(19) United States
(12) Patent Application Publication
(10) Pub. No.: US 2025/0166940 A1
(43) Pub. Date: May 22, 2025

(54) HIGH VOLTAGE ELECTRICALLY INSULATED THERMALLY CONDUCTIVE BYPASS HEAT SPREADER

(71) Applicant: Eaton Intelligent Power Limited, Dublin 4 (IE)

(72) Inventors: Brady GILCHRIST, Portland, OR (US); Vinayak S. KULKARNI, Pune (IN); Michael Scott SULLIVAN, Chelsea, MI (US); John B. ENGEL, Tigard, OR (US); Steven W. SHUYLER, Clackamas, OR (US); Matthew Alan CLARK, Milwaukie, OR (US)

(21) Appl. No.: 18/839,955

(22) PCT Filed: Feb. 21, 2023
(86) PCT No.: PCT/EP2023/025083

§ 371 Date: Aug. 20, 2024

(30) Foreign Application Priority Data
Feb. 21, 2022 (IN) 202211009061

(51) Int. Cl. H01H 9/52

(52) U.S. Cl. CPC H01H 9/52; H01H 2009/523; H01H 2009/526

(57) ABSTRACT

A bypass heat spreader includes a thermally conductive heat plate having a first end portion for contacting first terminal and second end portion for contacting second terminal, a first electrically insulative film encapsulating the first end portion, and a second electrically insulative film encapsulating the second end portion.

### BACKGROUND

High voltage applications require high voltage systems that can support large amounts of current being passed through the system. These current requirements mean that high voltage systems generate and accumulate a substantial amount of heat at the various system components. In high voltage electric vehicles, and other similar applications, space constraints can heavily impact the number and size of system components that are included. In particular, these space-constrained high voltage systems may only have allocated room for a single cooling device, such as a small cool plate or other heat rejection component. Often, the cooling device can only effectively cool the system components that are sufficiently proximate to that cooling device. For a switching device in such a space-constrained high voltage system that has one terminal proximate a cooling device, the remaining terminal may not be able to be cooled as effectively, resulting in an unevenly cooled switching device and a temperature gradient from one terminal of the switching device to the other terminal of the switching device.

The uneven cooling of switching devices can negatively impact the internal fixed and movable contacts of the switching device. For example, with a cool plate on only one side, heat can only be conducted from the uncooled side to the cooled side through the internal fixed and movable contacts, which are sized for electricity conduction. The conductive path for the electricity conduction within the switching device is not sufficient for heat conduction through the switching device and therefore is limited and insufficient to maintain terminal temperatures below the critical operating temperature of the switching device.

Thus, there is a need to more effectively disperse and transfer heat in systems in high voltage applications to regulate the temperature of the system components and prevent overheating with minimal negative impact to switching devices and their internal electrical components.

### BRIEF SUMMARY

High voltage electrically insulated thermally conductive bypass heat spreaders are described. The described bypass heat spreaders allow heat to be conducted from an uncooled side of a switching device to a cooled side of the switching device while maintaining high voltage electrical isolation. The heat transfer provided by a bypass heat spreader helps to reduce the thermal gradient from cooled to uncooled terminals (e.g., providing a more uniform heat distribution).

A bypass heat spreader includes a thermally conductive heat plate having a first end portion for coupling to an input terminal and second end portion for coupling to an output terminal, a first electrically insulative film encapsulating the first end portion, and a second electrically insulative film encapsulating the second end portion. The input terminal can be a first terminal of a switching device and the output terminal can be a second terminal of the switching device. The bypass heat spreader enables heat to be conducted between two terminals of a switching device (e.g., as a thermal bridge) while providing sufficient insulation for electrical isolation such that the switching device is not shorted when the switching device is in the open position.

The described bypass heat spreader is suitable for high voltage systems that include one or more switching devices. For example, a high voltage power distribution system, that includes an input bus bar, an output bus bar, a switch connected at a first terminal to the input bus bar and connected at a second terminal to the output bus bar, and a cool plate proximate to the output bus bar at the second terminal of the switch, can further include a bypass heat spreader coupled to the input bus bar at the first terminal of the switch and coupled to the output bus bar at the second terminal of the switch. The bypass heat spreader distributes heat from the first terminal of the switch (particularly from the input bus bar) towards the cool plate proximate to the output bus bar at the second terminal of the switch while bypassing the switch.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1A and FIG. 1C show views of an example operating environment for a bypass heat spreader.

FIG. 1B shows an example circuit diagram of the high voltage system shown in FIG. 1A.

FIG. 2A-FIG. 2D show various views of a bypass heat spreader.

FIG. 3A and FIG. 3B show details of a bypass heat spreader on a switch.

FIG. 4 illustrates heat flow for a high voltage system utilizing bypass heat spreaders.

FIG. 5 shows a view of a bypass heat spreader on a contactor.

### DETAILED DESCRIPTION

High voltage electrically insulated thermally conductive bypass heat spreaders are described. The described bypass heat spreaders allow heat to be conducted from an uncooled side of a switching device to a cooled side of the switching device while maintaining high voltage electrical isolation. The heat transfer helps to reduce the thermal gradient from cooled to uncooled terminals (e.g., providing a more uniform heat distribution).

“High voltage” generally refers to voltages of 600 V and higher and more commonly over 1,000 V for alternating current (AC) and over 1,500 for direct current (DC). High voltage switching devices include, but are not limited to, power electronic switches and contactors.

Advantageously, by providing a more uniform heat distribution, certain embodiments reduce wear on the switching components and reduce premature fatigue failure. Certain embodiments help to increase the maximum current carrying capacity (improved performance limits) of switching devices by reducing temperatures and better utilizing the full capacity of a cool plate or other heat rejection component.

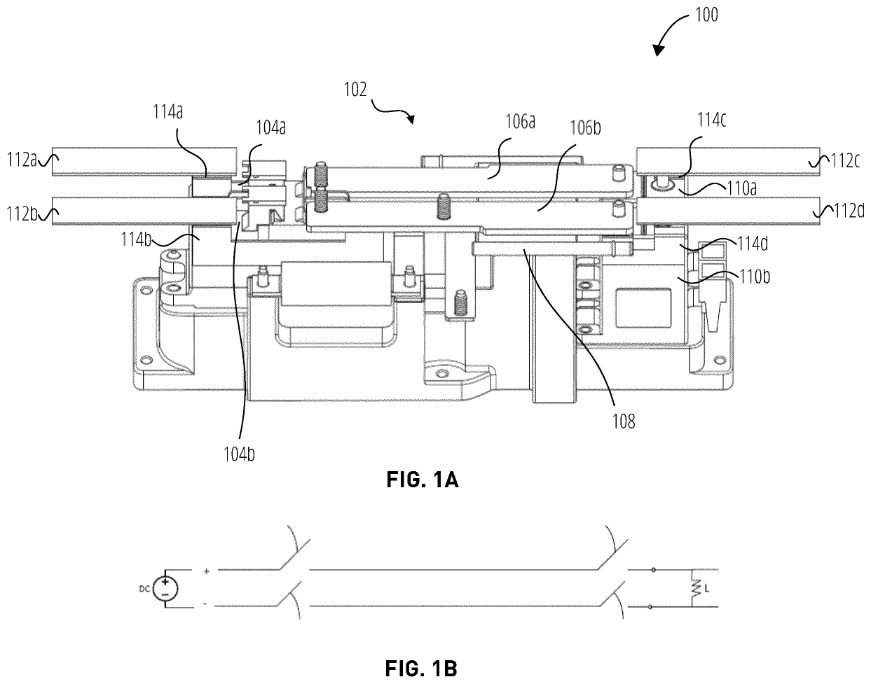

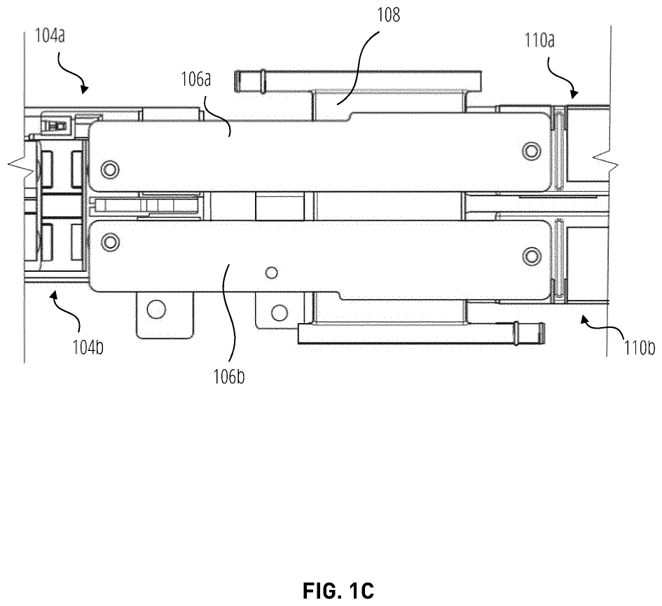

FIG. 1A and FIG. 1C show views of an example operating environment for a bypass heat spreader; and FIG. 1B shows an example circuit diagram of the high voltage system shown in FIG. 1A. Referring to FIG. 1A, operating environment 100 includes system 102, which can provide power distribution and protection in a high voltage electric vehicle application. Here, the system 102 is a multi-contactor system and includes a first switch 104a, a second switch 104b, a first inner bus bar 106a, a second inner bus bar 106b, a cool plate 108, a first contactor 110a, a second contactor 110b, and outer bus bars 112a-112d.

When operating in a high voltage application, the system 102 is exposed to large amounts of current. In some cases, the system 102 conducts current up to 750 A continuous at 1000V (and potentially even higher currents and voltages) through the components of system 102.

For example, with reference to FIG. 1A and FIG. 1B, system 102 may be coupled to a battery (not shown) of a high voltage electric vehicle at outer bus bar 112a and outer bus bar 112b, where outer bus bar 112a is coupled to a positive terminal of the battery and outer bus bar 112b is coupled to a negative terminal of the battery. Current is introduced by the battery into the system 102 and passed through a path composed of the outer bus bar 112a, the first switch 104a, the first inner bus bar 106a, and the first contactor 110a, and out through the outer bus bar 112c (e.g., to a load). Current may be reintroduced into the system 102 and passed through a path composed of the outer bus bar 112d, the second contactor 110b, the second inner bus bar 106b, and the second switch 104b, and out through outer bus bar 112b to the battery. As can be seen, when a system such as system 102 is utilized in a high voltage application, the system 102 may be consistently exposed to a great deal of current.

As current is passed through the components of system 102, the components accumulate a large amount of heat. For example, the bus bars (e.g., first inner bus bar 106a, second inner bus bar 106b, and outer bus bars 112a-112d) may be formed of copper, which is highly thermally conductive and easily retains heat. To regulate the temperature of the components of the system 102, the system 102 includes a cool plate 108 or other heat rejection component. The cool plate 108 is responsible for taking heat from the various components in the system 102 and transferring that heat to a single-phase liquid coolant within the cool plate 108.

However, as is the case for high voltage electric vehicle applications, the operating environment 100 may be utilized in an application with considerable space constraints. To conserve space, these systems may only be allocated space for, or have sufficient space for, a single heat rejection component, such as the cool plate 108.

As can be seen in FIG. 1A and FIG. 1C, system 102 includes the single cool plate 108 positioned under the first inner bus bars 106a and the second inner bus bar 106b. The first and second inner bus bars 106a-106b are positioned close enough to the cool plate 108 to be effectively cooled, as heat from the first and second inner bus bars 106a-106b can be easily transferred to the cool plate 108. Unfortunately, given the size and positioning of the cool plate 108, other elements of system 102, such as one side of each of the switches 104a-104b and the outer bus bars outer bus bars 112a-112d, are left partially, if not entirely, uncooled.

As mentioned above, conventionally, heat generated by the current passing through the switching devices just has the internal, electrical conductive paths of the switching devices to dissipate to the cooled side where the center cool plate is located, resulting in uneven cooling of each switching device and a temperature gradient from input terminals to output terminals of that switching device.

The uneven cooling particularly effects the switches 104a and 104b, as uneven cooling of switching devices leads to expansion and contraction at varying rates on the different sides of the switches 104a and 104b. Additionally, because only the inner side (i.e., the side facing the cool plate 108) of each switch 104a and 104b is being cooled, the internal components of the switches 104a and 104b are not being appropriately cooled and can remain immoderately hot. These negative effects of uneven cooling similarly apply to both the first contactor 110a and the second contactor 110b.

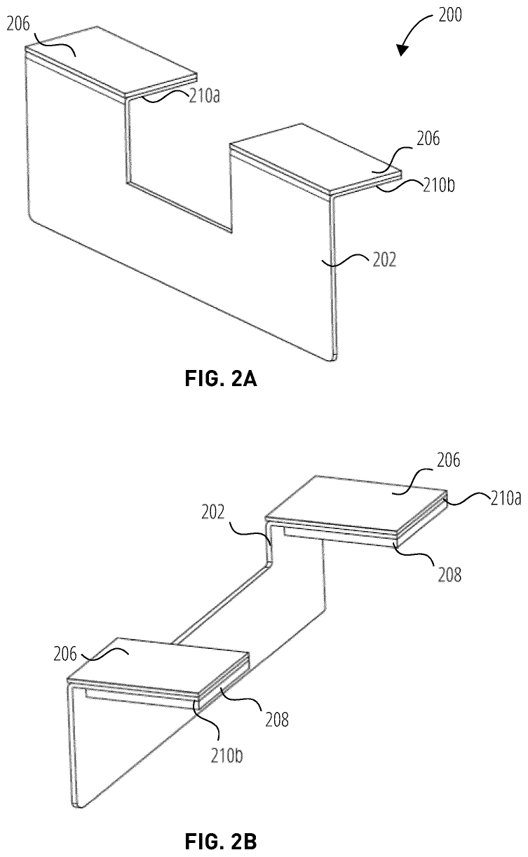

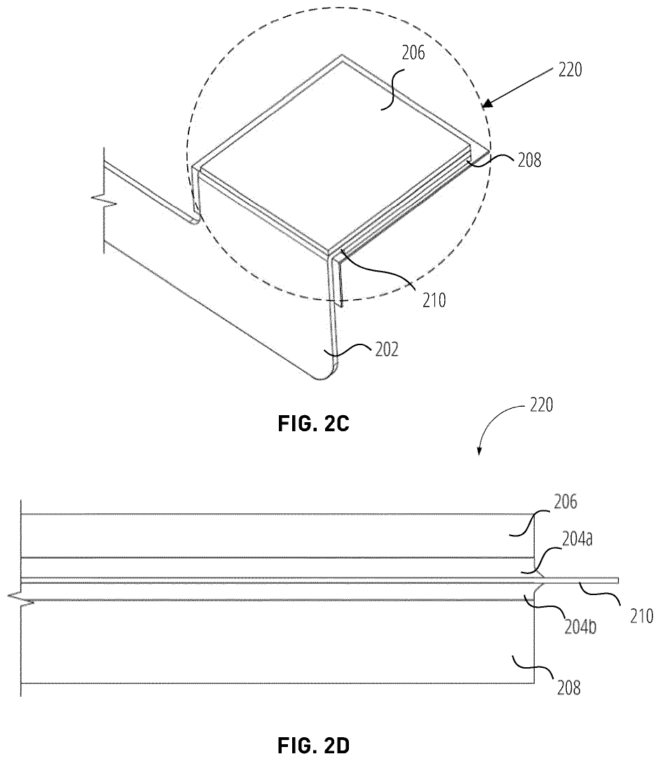

Therefore, to compensate for the insufficient and uneven colling of system 102, system 102 utilizes a plurality of bypass heat spreaders 114a-114d as described herein for improving the heat distribution for the switching components (e.g., first switch 104a, second switch 104b, first contactor 110a, and second contactor 110b) of the system 102. Bypass heat spreaders 114a-114d may be embodied as described with respect to bypass heat spreader 200 of FIG. 2A-FIG. 2D.

FIG. 2A-FIG. 2D show various views of a bypass heat spreader. Referring to FIG. 2A-FIG. 2B, a bypass heat spreader 200 includes a thermally conductive heat plate 202 having a first end portion 210a for coupling to an input terminal (e.g., a first terminal of a switching device) and a second end portion 210b for coupling to an output terminal (e.g., a second terminal of the switching device); a first electrically insulative film 204a encapsulating the first end portion 210a; and a second electrically insulative film 204b encapsulating the second end portion 210b.

Most materials that are thermally conductive (i.e., a material capable of and effective for transferring heat) are also electrically conductive. This makes it difficult to transfer heat across electrical components (such as switching devices of the system 102) using a thermally conductive material. The electrically conductive properties of the thermally conductive material can create electrical interference with the switching devices, which can result in a short. The electrically insulative film that encapsulates the end portions of the thermally conductive heat plate prevents a short at the switching device. In some cases, the entire thermally conductive heat plate of the bypass heat spreader is encapsulated by the electrically insulative film. However, it is not necessary to do so and it is possible to just encapsulate the end portions.

Bypass heat spreader 200 allows terminals on an uncooled side of a switching device to conduct heat to the cooled side, while maintaining high voltage electrical isolation. Bypass heat spreader 200 is suitable for any switching device including, but not limited to, electric circuit breakers, residual current circuit breakers, circuit breakers, namely, electric circuit interrupters, fuses, electric switches, electric relays, over-current electrical protectors, namely, surge protectors, fuses, circuit breakers, surge protectors, power quality conditioners, namely, power line conditioners, electrical power distribution units, electrical components in the nature of electric contactors, electrical junctions, namely, electric junction boxes, battery management system comprising computer hardware and software for the control of the charge and discharge of batteries, circuit overload protector devices, electrical switches, namely, voltage interrupters, electrical disconnect switches, emergency power switch, circuit breakers, battery overload protectors, namely, fuses, electronic power conversion devices, namely, battery equalizer, battery charger, electric meters, namely, electric load indicator and electric power indicator, temperature protection system comprising internal or external temperature sensors, electrical switches, solar panel protector comprising electrical overcurrent, short circuit, and emergency power shut-off switches, electrical switches, namely, fuel cell protector switches, and all of the foregoing for use in vehicles or stationary applications.

FIG. 2C and FIG. 2D illustrate a detail of layers of a terminal contacting portion of a bypass heat spreader 200. The terminal contacting portion 220 of the bypass heat spreader 200 thermally couples to an input terminal or output terminal of a device (e.g., a switching device). The terminal contacting portion 220 of bypass heat spreader 200 includes a portion 210 (e.g., first end portion 210a or second end portion 210b) of the thermally conductive heat plate 202 and an electrically insulative film 204 above and below the portion 210 of the thermally conductive heat plate 202.

The thermally conductive heat plate 202 can be formed of a thin sheet of thermally conductive material, such as copper or graphene. For example, the thermally conductive material may be a material on a scale of 100-150 W/mK. In some cases, the thermally conductive heat plate 202 is formed of a material that is thermally conductive in-plane, but not through-plane.

The electrically insulative film 204 allows for a high dielectric strength (typically >5 kV), which is critical in maintaining electrical isolation while simultaneously providing the thermal heat transfer. The electrically insulative film 204 may be formed of any electrically insulative material, such as a polyimide film (e.g., Kapton®). In some cases, the electrically insulative film 204 is in the form of a pouch of electrically insulative material. Electrically insulative film 204 tends to have some thermal insulative properties, but because the electrically insulative film 204 is very thin (e.g., microns thin) the heat transfer coefficient remains low.

In some cases, the terminal contacting portion 220 of the bypass heat spreader 200 further includes a gap pad 206, for example as shown in FIG. 2A. In some cases, the terminal contacting portion 220 of the bypass heat spreader 200 further includes a non-thermally conductive riser 208. In some cases, the terminal contacting portion 220 of the bypass heat spreader 200 further includes both a gap pad 206 and a non-thermally conductive riser 208, for example as shown in FIG. 2B.

The gap pad 206 is formed of a thermally conductive material. For example, the gap pad 206 may be a material that has a thermal conductivity of 3 Watts/mK. The gap pad 206 can be used to assist with contacting bus bars or other components through which the bypass heat spreader can couple to an input terminal or an output terminal. Indeed, the gap pad 206 can be used to reduce the thermal contact resistance between the two materials (e.g., of the thermally conductive heat plate/electrically insulative film and the bus bar), resulting in more heat conduction from the bus bars to the heat spreaders and ultimately improved thermal transfer and improved effectiveness of the system cooling (e.g., the cool plate).

The non-thermally conductive riser 208 is made of a compressible material. The non-thermally conductive riser 208 can be used to assist with attaching to the packaging of the switching device. The non-thermally conductive riser 208 fills any additional space or gaps between the switching device and the overlaying device that is not already filled by the thermally conductive heat plate 202, the electrically insulative film 204, and the gap pad 206. The non-thermally conductive riser 208 may be included to fill additional space, ensuring that the bypass heat spreader 200 remains securely in place. In some cases, the non-thermally conductive riser 208 is formed of a compressible material, such that when parts are screwed down, upwards pressure compresses the stack so there is less room for air pockets, bubbles, and other surface imperfections. The inclusion of a non-thermally conductive riser 208 ensures stability of the bypass heat spreader 200 and any underlying parts.

It is possible to fabricate a bypass heat spreader by a formed (e.g., stamped, cast, or other method) thermally conductive material with electrical isolation material (e.g., polyimide film or other isolation material) encapsulating at least the surface area that makes physical contact with a high voltage bus bar. In some cases, the thermally conductive heat plate 202 includes a first bend forming the first end portion 210a (e.g., with a single flange shape) and a second bend forming the second end portion 210b (e.g., with a single flange shape). In some cases, the thermally conductive heat plate 202 is flat (e.g., sheet-type with no bends). In some cases, the thermally conductive heat plate 202 is U-shaped. In various implementations, the thermally conductive heat plate 202 may be any shape/form, such that it includes a first end portion for coupling to a first terminal of a switching device and a second end portion for coupling to a second terminal of the switching device.

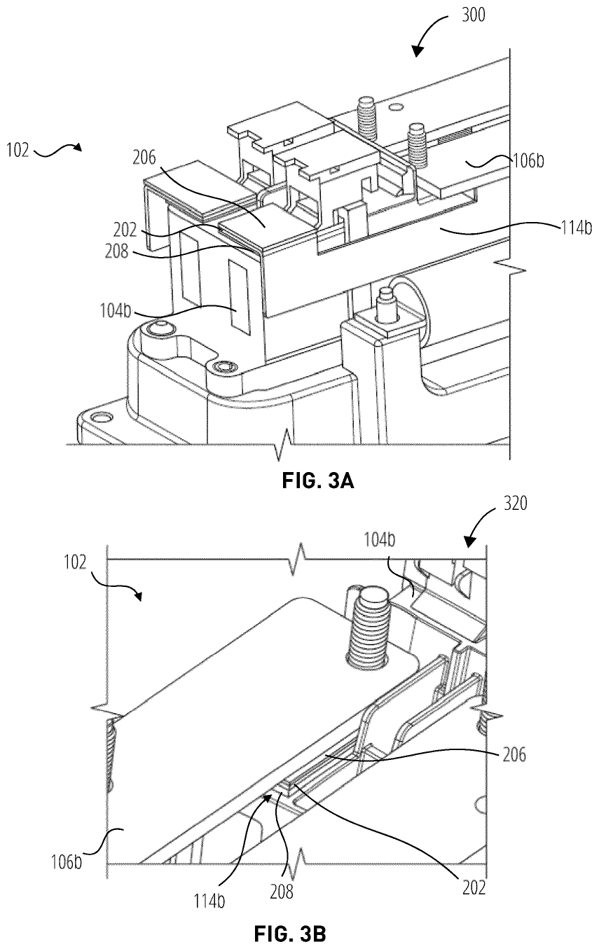

FIG. 3A and FIG. 3B show details of a bypass heat spreader on a switch. Referring to FIG. 3A, which shows a perspective left front side cutaway view 300 of the system 102, the second bypass heat spreader 114b includes a non-thermally conductive riser 208 that contacts the surface of the first terminal side of the second switch 104b and a thermally conductive heat plate 202 that maintains a slim profile along the side of the switch 104b to contact the second inner bus bar 106b at its second end portion (not shown in FIG. 3A).

Referring to FIG. 3B, which shows a perspective left back side view 320 of the connection between the second bypass heat spreader 114b and the second inner bus bar 106b, the gap pad 206 of the second bypass heat spreader 114b at the second end portion of the thermally conductive heat plate 202 contacts the second inner bus bar 106b and the non-thermally conductive riser 208 contacts the surface of the second terminal side of the second switch 104b

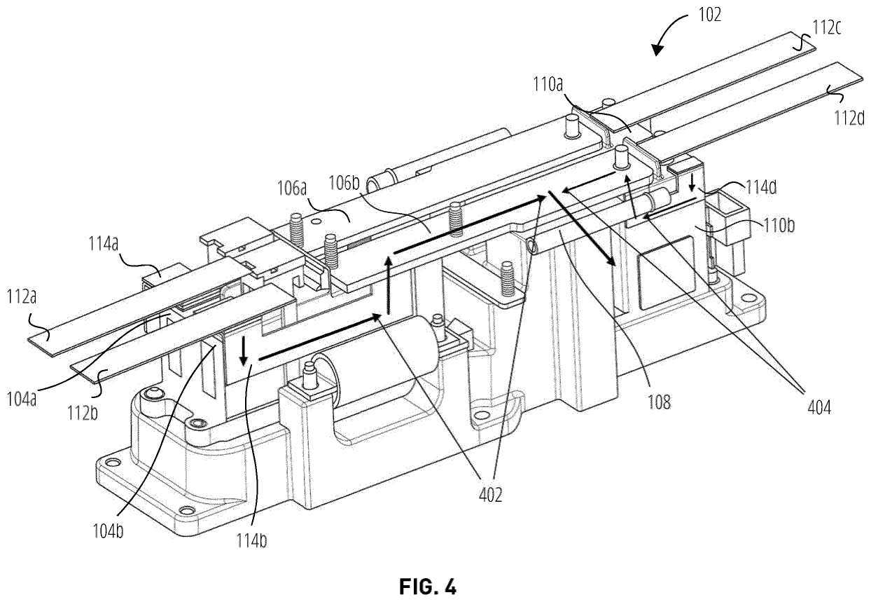

FIG. 4 illustrates heat flow for a high voltage system utilizing bypass heat spreaders. FIG. 4 shows the heat flow through system 102 utilizing bypass heat spreaders 114a-114d. Outfitting a system, like system 102, with a bypass heat spreader at a switching device allows for distribution of overaccumulation of heat within the system without sacrificing space. The bypass heat spreaders 114a-114d each create a thermal bridge between two terminals of a switching device that bypasses the corresponding switching devices' electrical components and facilitates the transfer of heat from the periphery of the system (e.g., outer bus bars 112a-112d) towards the centrally positioned cool plate 108.

The heat distribution arrows 402 illustrate the transfer of heat from the outer end of the second switch 104b (and heat from the outer bus bar 112b) across the second bypass heat spreader 114b to the second inner bus bar 106b and to the cool plate 108.

The second bypass heat spreader 114b conducts heat from the first terminal of the second switch 104b and the outer bus bar 112b, allowing the heat to spread over the surface area of the second bypass heat spreader 114b. In utilizing the second bypass heat spreader 114b, the heat can be dispersed across the second bypass heat spreader 114b. As the heat is spread across the second bypass heat spreader 114b, the heat is transferred towards the cool plate 108 (along an inner bus bar “second inner bus bar” 106b. The electrically insulative film of the second bypass heat spreader 114b allows the second bypass heat spreader 114b to connect to both terminals of the second switch 104b without causing electrical interference. The second bypass heat spreader 114b bypasses the second switch 104b, so as to not cause interference with the functionality of the electrical components within the second switch 104b.

The heat distribution arrows 404 illustrate the transfer of heat from the outer end of the second contactor 110b (and heat from the outer bus bar 112d) towards the cool plate 108 (along the inner bus bar “second inner bus bar 106b).

In this manner, each of the plurality of bypass heat spreaders works to distribute heat produced by the system by increasing the surface area of thermally conductive material and facilitating the transfer of that heat towards the cool plate 108.

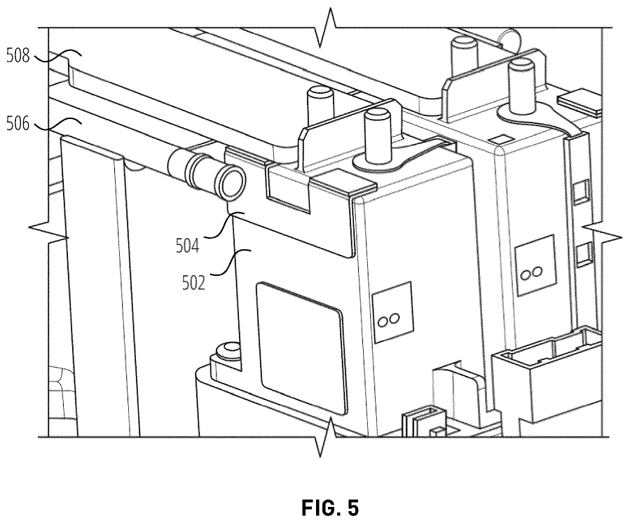

FIG. 5 shows a view of a bypass heat spreader on a contactor. Referring to FIG. 5, bus bars for a contactor or other high voltage switching device can be in line with output bus bars to make full contact with a bypass heat spreader, for example, through a thermal gap pad. As shown, the bypass heat spreader 504 can conduct heat from one terminal of the contactor 502 (e.g., through an output bus bar not shown connected to the contactor terminal) to another terminal of the contactor 502 through the bus bar 508 to a cool plate 506.

In some embodiments, a bypass heat spreader is used to provide a cooled contactor. In some embodiments, a bypass heat spreader is configured as a thermal bridge between an input and an output. A cool plate can be between the input and the output. In some embodiments, a bypass heat spreader is a two-terminal electrical component that includes a thermally conductive component formed in a U-shape; an electrical isolation material encapsulating a surface area that makes physical contact with a high voltage bus bar; and a thermal gap pad or other thermally conductive material between the electrical isolation material and the high voltage bus bar.

In some cases, a system is provided that includes bus bars; a pair of high voltage contactors comprising input terminals and output terminals; a central cool plate located to cool the bus bars and located in proximity to the output terminals, the cool plate comprising coolant; a thermal gap pad; an electrical isolation material; and heat spreaders comprising a thermally conductive material, wherein the system is configured to transfer heat from the input terminals, through the thermal gap pad, and into the thermally conductive material of the heat spreader, and wherein the heat is then conducted through the thermally conductive material to the electrical isolation material, and the thermal gap pad, and into an output bus bar connected to the output terminal, and wherein the heat from the output bus bar is conducted to the cool plate and from the cool plate to the coolant.

In an embodiment, a bypass heat spreader includes a thermally conductive heat plate having a first end portion for coupling to an input terminal and a second end portion for coupling to an output terminal; a first electrically insulative film encapsulating the first end portion; a second electrically insulative film encapsulating the second end portion; a first thermal gap pad on the first electrically insulative film at the first end portion; and optionally a first compressible riser at the first end portion of the thermally conductive heat plate. In a further embodiment, the bypass heat spreader includes a second thermal gap pad on the second electrically insulative film at the second end portion; and optionally a second compressible riser at the second end portion of the thermally conductive heat plate.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

1. A bypass heat spreader, comprising:
a thermally conductive heat plate having a first end portion for coupling to an input terminal and a second end portion for coupling to an output terminal;
a first electrically insulative film encapsulating the first end portion; and
a second electrically insulative film encapsulating the second end portion.

2. The bypass heat spreader of claim 1, wherein the input terminal is a first terminal of a switching device and the output terminal is a second terminal of the switching device.

3. The bypass heat spreader of claim 1, further comprising:
a first thermal gap pad on the first electrically insulative film at the first end portion; and
a second thermal gap pad on the second electrically insulative film at the second end portion.

4. The bypass heat spreader of claim 3, wherein the first thermal gap pad and the second thermal gap pad comprise a material that has a thermal conductivity of 3 Watts/mK.

5. The bypass heat spreader of claim 3, further comprising:
a first compressible riser at the first end portion of the thermally conductive heat plate; and
a second compressible riser at the second end portion of the thermally conductive heat plate.

6. The bypass heat spreader of claim 5, wherein the first compressible riser and the second compressible riser comprise a non-thermally conductive material.

7. The bypass heat spreader of claim 1, wherein the thermally conductive heat plate is copper.

8. The bypass heat spreader of claim 1, wherein the thermally conductive heat plate is U-shaped.

9. The bypass heat spreader of claim 1, wherein the thermally conductive heat plate further comprises:
a first bend forming the first end portion; and
a second bend forming the second end portion.

10. The bypass heat spreader of claim 1, wherein the first electrically insulative film and the second electrically insulative film are a polyimide film.

11. A high voltage system comprising:
a switching device; and
a bypass heat spreader comprising:
a thermally conductive heat plate having a first end portion for coupling to a first terminal of the switching device and a second end portion for coupling to a second terminal of the switching device;
a first electrically insulative film encapsulating the first end portion; and
a second electrically insulative film encapsulating the second end portion.

12. The high voltage system of claim 11, further comprising:
an input bus bar;
an output bus bar; and
a cool plate proximate to the output bus bar at the second terminal of the switching device,
wherein the switching device is connected at the first terminal to the input bus bar and connected at the second terminal to the output bus bar, and
wherein the bypass heat spreader distributes heat from the input bus bar and towards the cool plate while bypassing the switching device.

13. The high voltage system of claim 12, wherein the bypass heat spreader further comprises:
a first thermal gap pad on the first electrically insulative film at the first end portion, the first thermal gap pad contacting the input bus bar;
a first compressible riser at the first end portion of the thermally conductive heat plate between the first end portion and a surface of the switching device proximate the first terminal;
a second thermal gap pad on the second electrically insulative film at the second end portion; and
a second compressible riser at the second end portion of the thermally conductive heat plate between the second end portion and a surface of the switching device proximate the second terminal.

14. The high voltage system of claim 11, wherein the switching device is a contactor.

15. The high voltage system of claim 11, wherein the switching device is a circuit breaker.
